(19) United States
(12) Patent Application Publication
(10) Pub. No.: US 2011/0205873 A1
(43) Pub. Date: Aug. 25, 2011

(54) LONG SEEK CONTROL SYSTEM AND METHOD THEREOF USED IN OPTICAL INFORMATION REPRODUCTION/RECORDING SYSTEM

(75) Inventors: Hsuan-Ju CHEN, Hsinchu County (TW); Shih-Peng Tai, Taoyuan County (TW)

(73) Assignee: NOVATEK MICROELECTRONICS CORP., Hsinchu (TW)

(21) Appl. No.: 13/032,230

(22) Filed: Feb. 22, 2011

(30) Foreign Application Priority Data
Feb. 22, 2010 (TW) 99105066

(51) Int. Cl. G11B 7/00

(52) U.S. Cl. 369/44.28; G9B/7

(57) ABSTRACT

A long seeking control method, for an optical information reproduction/recoding system having a lens and a sledge, includes: obtaining a sledge estimation velocity, a sledge estimation displacement, a sledge reference velocity and a first force applied to the sledge; determining to generate the sledge estimation velocity and the sledge estimation displacement in a first open loop control or in a first close loop control based on the sledge estimation velocity; determining to generate the a second force applied to the lens in a second open loop control or in a second close loop control based on the sledge estimation velocity; and pushing the sledge and the lens by the first force and the second force.

This application claims the benefit of Taiwan application Serial No. 99105066, filed Feb. 22, 2010, the subject matter of which is incorporated herein by reference.

### TECHNICAL FIELD

The disclosure relates in general to a long seeking control system and a method thereof for an optical information reproduction/recoding system.

### BACKGROUND

In accessing data from an optical disc, how to quickly and stably access disc data so as to reduce data accessing time is a prominent task for the industries. An optical disc has many tracks for storing digital data.

In accessing data from the optical disc, a disc drive performs the following operations: driving a spindle motor to rotate the disc; moving an optical head to inner tracks of the disc; driving a focus servo, so that the laser light emitted by the optical head is projected on the disc; driving a tracking servo to move lens of the optical head so that the laser light spot tracks one single data track for tracking; reading a track number of the current track to obtain the position of the current track; performing a long seeking for moving the optical head towards the target track from the current track; performing tracking and reading the track number of the track in which the optical head is currently located to obtain the difference between the track number of the current track and that of the target track; performing a short seeking for moving the laser light spot to the target track; and performing tracking and accessing data.

Long seeking is a primary factor for data accessing time. However, if the quality of the servo signal such as tracking error signal is poor, the operation of the long seeking is severely affected. Poor-quality servo signal may lead to error in the counting of remaining tracks and in the estimation of the jump velocity or may even result in the failure in the long seeking. In addition, when the sledge velocity is high, the servo signal is severely distorted. To avoid seeking failure, the movement of the sledge is set at a low speed, making the long seeking spend a large amount of time in seeking.

### BRIEF SUMMARY

The disclosure is directed to a long seeking control system and a method thereof, not only estimating the sledge velocity, but also estimating the sledge displacement.

An exemplary embodiment of a long seeking control method for an optical information reproduction/recoding system having a lens and a sledge is provided. The method includes: obtaining a sledge estimation velocity, a sledge estimation displacement, a sledge reference velocity and a first force applied to the sledge; determining to generate the sledge estimation velocity and the sledge estimation displacement by a first open loop control or a first close loop control according to the sledge estimation velocity; determining to generate a second force applied to the lens by a second open loop control or a second close loop control according to the sledge estimation velocity; and pushing the sledge and the lens by the first force and the second force.

Another exemplary embodiment of a long seeking control system for an optical information reproduction/recoding system having a lens and a sledge includes a second order observing unit, a jump profile generator, a gain control unit, and a lens controller. The second order observing unit generates a sledge estimation displacement signal and a sledge estimation velocity signal and further generates the sledge estimation velocity and the sledge estimation displacement by a first open loop control or a first close loop control according to the sledge estimation velocity. The jump profile generator generates a sledge reference velocity signal according to the sledge estimation displacement signal. The gain control unit generates a first force applied to the sledge according to the sledge estimation velocity signal and the sledge reference velocity signal. The lens controller generates a second force, applied to the lens according to the sledge estimation velocity signal and the first force signal, and generates the second force applied to the lens by a second open loop control or a second close loop control according to the sledge estimation velocity.

It is to be understood that both the foregoing general description and the following detailed description are exemplary and explanatory only and are not restrictive of the disclosed embodiments, as claimed.

### BRIEF DESCRIPTION OF THE DRAWINGS

FIG. 1 shows a functional block diagram of an optical information reproduction/recoding system according to an embodiment of the disclosure;

FIG. 2 shows a physical model of a sledge actuator and a lens actuator;

FIG. 3A shows a step response of a sledge;

FIG. 3B shows a sledge reference velocity signal generated by a jump profile generator;

FIG. 3C shows an amplitude frequency response of a lens;

FIG. 3D shows a phase frequency response of a lens; and

FIG. 4A and FIG. 4B show a flow chart according to the present embodiment of the disclosure.

### DETAILED DESCRIPTION OF EXEMPLARY EMBODIMENT OF THE PRESENT DISCLOSURE

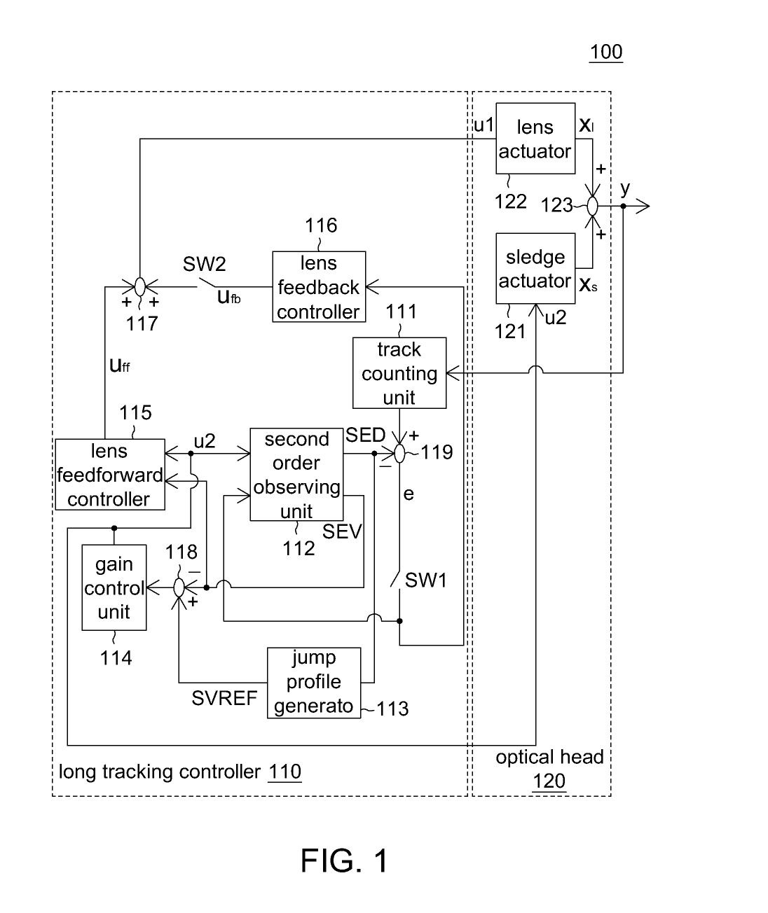

FIG. 1 shows a functional block diagram of an optical information reproduction/recoding system according to an embodiment of the disclosure. The optical information reproduction/recoding system 100 is for example but not limited by a CD disc drive, a DVD disc drive, a blue ray disc drive and so on. As indicated in FIG. 1, the optical information reproduction/recoding system 100 according to the embodiment of the disclosure includes a long tracking controller 110 and an optical head 120. The long tracking controller 110 includes a track counting unit 111, a second order observing unit 112, a jump profile generator 113, a gain control unit 114, a lens feedforward controller 115, a lens feedback controller 116, calculating units 117˜119 and switches SW1˜SW2. The optical head 120 includes a sledge actuator 121, a lens actuator 122 and a calculating unit 123. The optical head 120 emits a laser light for accessing and recording disc data.

In FIG. 1, the signal y denotes the displacement of a laser beam, and is the sum of the displacement signals xₗ and xₛ (y=xₗ+xₛ); the displacement signal xₛ denotes the displacement of the sledge with respect to the ground, and the signal xₗ denotes the displacement of the lens with respect to the sledge (the lens is disposed above the sledge). The sledge actuator 121 and the lens actuator 122 respectively push the sledge and the lens according to the signals u2 and u1. The signal y is outputted from the calculating unit 123.

The track counting unit 111 calculates the amount of the tracks crossed by the laser beam (that is, the amount of the tracks crossed by the optical head) according to the displacement signal y. The second order observing unit 112 generates a sledge estimation displacement signal SED and a sledge estimation velocity signal SEV according to the signal u2 and an error signal e. The unit of the sledge estimation displacement signal is track, and the unit of the sledge estimation velocity signal SEV is Hertz (Hz). If the sledge is in low speed, then the error signal e is inputted to the second order observing unit 112. To the contrary, if the sledge is in a high speed, then the error signal e is not inputted to the second order observing unit 112. The jump profile generator 113 generates a sledge reference velocity signal SVREF according to the sledge estimation displacement signal SED, wherein the unit of the sledge reference velocity signal SVREF is Hz. The gain control unit 114 generates the signal u2 to the sledge actuator 121, the second order observing unit 112 and the lens feedforward controller 115 according to a difference between the sledge estimation velocity signal SEV and the sledge reference velocity signal SVREF. The lens feedforward controller 115 generates a lens feedforward control signal u_{ff} according to the sledge estimation velocity signal SEV and the signal u2. In a low speed, the lens feedback controller 116 generates a lens feedback control signal u_{fb} according to the error signal e. The calculating unit 117 adds up the lens feedforward control signal u_{ff} and the lens feedback control signal u_{fb} (when the switch SW2 is turned on) and outputs the signal u1 to the lens actuator 122. The calculating unit 118 calculates the difference between the sledge estimation velocity signal SEV and the sledge reference velocity signal SVREF. The calculating unit 119 calculates a difference between the sledge estimation displacement signal SED and the amount of the tracked crossed by the laser beam and outputs the error signal e, wherein e=TC-SED, and TC denotes the amount of the tracked crossed by the laser beam.

The ON/OFF state of the switches SW1˜SW2 is controlled by the sledge estimation velocity signal SEV. When the sledge estimation velocity signal SEV is higher than the first velocity threshold Vth1, the switch SW1 is turned off; and vice versa. When the sledge estimation velocity signal SEV is higher than the second velocity threshold Vth2, the switch SW2 is turned off; and vice versa. The second velocity threshold Vth2 is smaller than the first velocity threshold Vth1. When the sledge is accelerated from a low speed (that is, the sledge estimation velocity signal SEV increases), turn off of the switch SW2 is earlier than turn off of the switch SW1. On the other hand, when the sledge is decelerated from high speed (that is, the sledge estimation velocity signal SEV decreases), turn on of the switch SW1 is earlier than turn on of the switch SW2. Thus, the sledge velocity and the ON/OFF state of the switches SW1˜SW2 are as below:

| Low Speed | Medium Speed | High Speed |
|---|---|---|
| (SEV < Vth2) | (Vth2 < SEV < Vth1) | (SEV > Vth1) |
| SW1 ON | SW1 ON | SW1 OFF |
| SW2 ON | SW2 OFF | SW2 OFF |

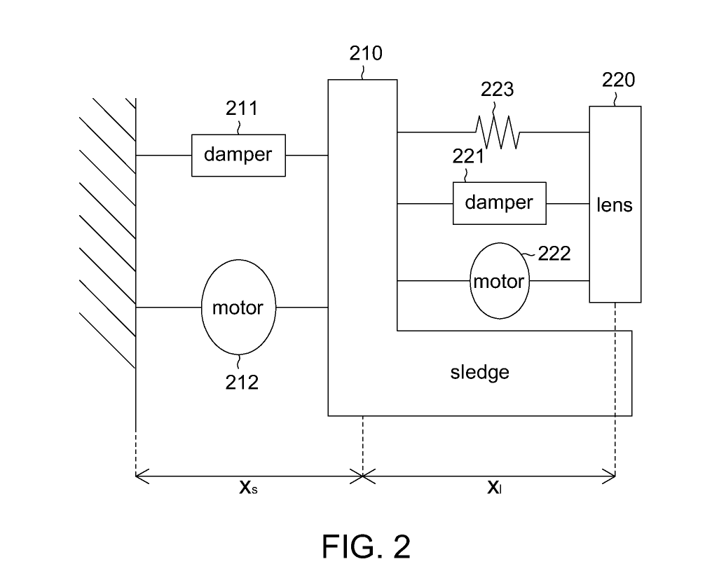

Referring to FIG. 2, a physical model of the sledge actuator 121 and the lens actuator 122 is shown. The sledge 210 and the lens 220 are respectively pushed by motors 212 and 222; and a spring 223 is further disposed between the lens 220 and the sledge 210. According to FIG. 2, the accelerations of the lens and the sledge are respectively expressed as:

$$\begin{matrix}{\ddot{x}}_{l} = - b {\dot{x}}_{l} - {kx}_{l} + {k}_{1} {u}_{1} - {\ddot{x}}_{s} & ( 1 ) \\ {\ddot{x}}_{s} = \frac{{m}_{l}}{{m}_{s}} ( b {\dot{x}}_{l} + {kx}_{l} - {k}_{1} {u}_{1} ) - p {\dot{x}}_{s} + {k}_{2} {u}_{2} & ( 2 )\end{matrix}$$

In the above, mₗ denotes the lens mass; mₛ denotes the sledge mass; k=LEM/mₗ, LEM denotes the lens elasticity modulus; b=LDC/mₗ, LDC denotes the lens damping coefficient, that is, the coefficient of the damper 221; p=SDC/mₛ, SDC denotes the sledge damping coefficient, that is, the coefficient of the damper 211.

If

$$X = [ \begin{matrix}{x}_{l} \\ {\dot{x}}_{l} \\ {x}_{s} \\ {\dot{x}}_{s}\end{matrix} ] , and \frac{{m}_{l}}{{m}_{s}}$$

is neglected (this is because the lens mass mₗ<<the sledge mass mₛ), then the above equations (1) and (2) can be arranged as follows:

$$\dot{X} = [ \begin{matrix}0 & 1 & 0 & 0 \\ - k & - b & 0 & p \\ 0 & 0 & 0 & 1 \\ 0 & 0 & 0 & - p\end{matrix} ] X + [ \begin{matrix}0 & 0 \\ {k}_{1} & - {k}_{2} \\ 0 & 0 \\ 0 & {k}_{2}\end{matrix} ] [ \begin{matrix}{u}_{1} \\ {u}_{2}\end{matrix} ] \qquad ( 3 )$$

Thus, the laser beam displacement signal y can be expressed as:

y=[1 0 1 0]X (4)

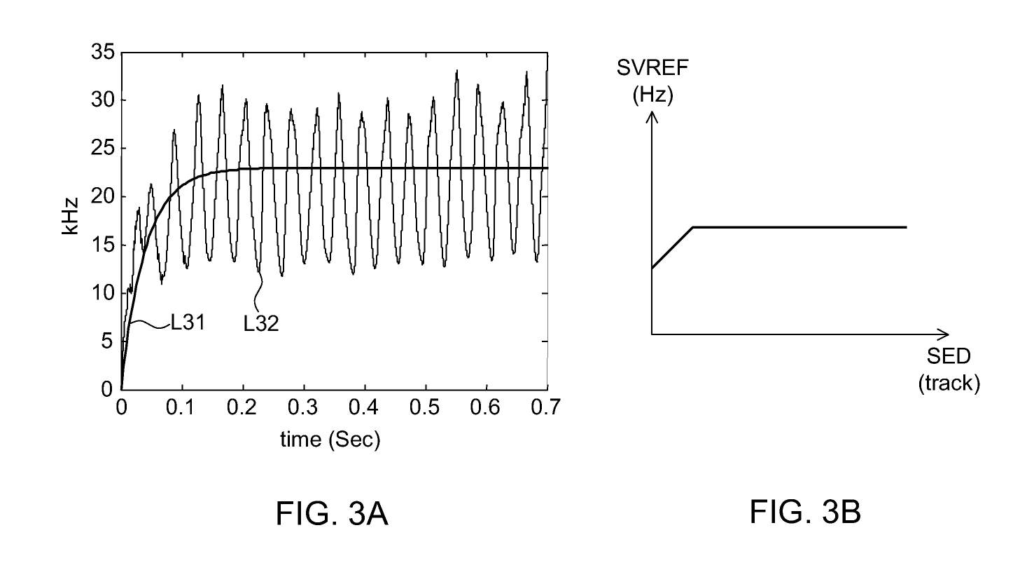

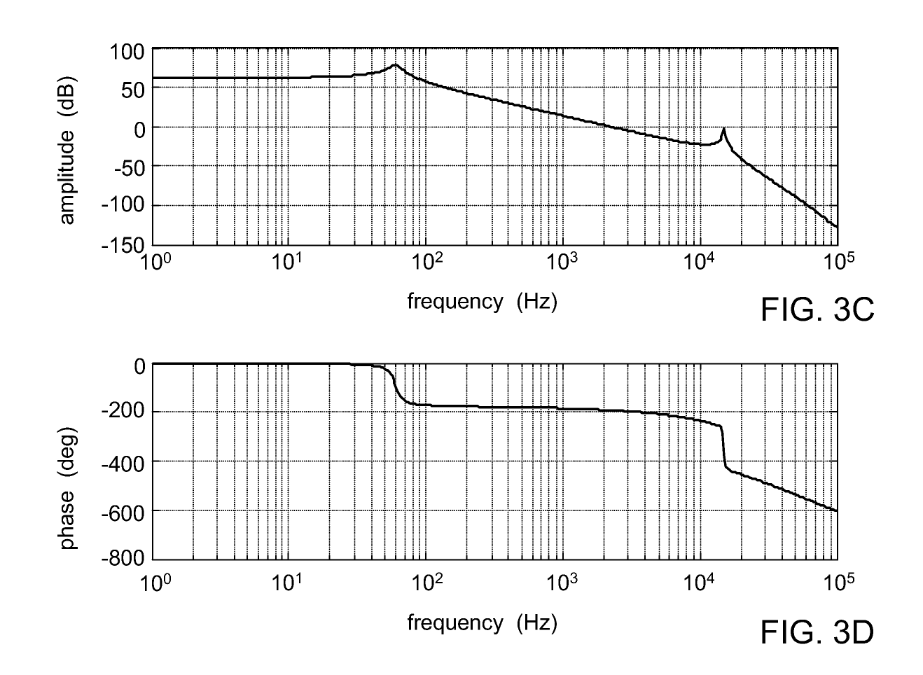

Now describe how to obtain the parameters k and p. Firstly, a known and fixed force is applied to the sledge (the force is only applied to the sledge, but not to the lens), so that the sledge crosses over a number of tracks, and a tracking error (TE) signal is obtained, and further the sledge velocity is estimated based on the tracking error signal. Next, the step response of the sledge is estimated and its transfer function is obtained as indicated in FIG. 3A. In FIG. 3A, L31 denotes the estimated sledge velocity, and L32 denotes the sum of the actual sledge velocity and the actual lens velocity.

The operations of the elements of the long tracking controller 110 are disclosed below.

The second order observing unit 112 obtains the sledge estimation displacement signal SED and the sledge estimation velocity signal SEV according to the equation below:

$${X}^{\dot{\hat{}}} [ \begin{matrix}0 & 1 \\ 0 & - p\end{matrix} ] \hat{X} + [ \begin{matrix}0 \\ {k}_{2}\end{matrix} ] {u}_{2} + [ \begin{matrix}{l}_{1} \\ {l}_{2}\end{matrix} ] e \qquad ( 5 )$$

Wherein,

$$\hat{X} = [ \begin{matrix}\hat{{x}_{s}} \\ {{x}_{s}}^{\dot{\hat{}}}\end{matrix} ]$$

denotes the sledge estimation displacement signal SED and the sledge estimation velocity signal SEV, that is, \hat{x}ₛ and {circumflex over (\dot{x}ₛ respectively denote the sledge estimation displacement signal SED and the sledge estimation velocity signal SEV; the parameters l₁ and l₂ determine the observer pole of the second order observing unit. The observer pole determines the convergence velocity of the error, wherein the error comes from a difference between the mathematical model and the reality. If the convergence velocity is fast, then the correction of the error is fast as well, but the noise will be amplified.

The sledge reference velocity signal SVREF generated by the jump profile generator 113 is indicated in FIG. 3B. Since the target track number is given before the track seeking and/or the track jumping, the jump profile generator 113 determines the sledge reference velocity signal SVREF according to the target track number and the sledge estimation displacement signal SED (which denotes the estimated amount of the tracks crossed).

The gain control unit 114 generates the signal u2 according to the difference between the sledge estimation velocity signal SEV and the sledge reference velocity signal SVREF, wherein u2 is expressed as:

u2=CG*(SVREF−SEV) (6)

CG denotes the control gain.

As indicated in FIG. 1, the signal u1 applied to the lens actuator 122 is expressed as: u₁=u_{ff}+u_{fb}. To decrease the inertial force applied to the lens, u_{ff} is expressed as:

$${u}_{ff} = \frac{{\ddot{x}}_{s}}{{k}_{1}} = \frac{{k}_{2}}{{k}_{1}} {u}_{2} - \frac{p}{{k}_{1}} {\dot{x}}_{s} \qquad ( 7 )$$

Thus, the equation (1) is expressed as:

\ddot{x}ₗ=−b\dot{x}ₗ−kxₗ+k₁u_{fb} (8)

In general, \dot{x}ₛ cannot be obtained directly. By replacing \dot{x}ₛ with {dot over (\hat{x}ₛ which can be obtained by the second order observing unit, the equation (8) is expressed as:

$${u}_{ff} = \frac{{\ddot{x}}_{s}}{{k}_{1}} = \frac{{k}_{2}}{{k}_{1}} {u}_{2} - \frac{p}{{k}_{1}} {\dot{x}}_{s} \qquad ( 9 )$$

To obtain the parameters b,k₁ and k, the frequency response of the lens is obtained by such as but not limited by a dynamic signal analyzer. FIG. 3C shows an amplitude frequency response of a lens. FIG. 3D shows a phase frequency response of a lens. The mathematical model of the frequency response of a lens can be obtained in this manner.

The lens feedback controller 116 reduces a relative velocity of the lens with respect to the sledge and also decreases the oscillation of the lens. When in a low speed, the lens feedback controller 116 generates a lens feedback control signal u_{fb} according to the error signal e. On the other hand, the error signal e (e=y−\hat{x}ₛ) is regarded as the difference between the laser beam displacement signal y and the sledge estimation displacement \hat{x}ₛ estimated by the second order observing unit 112.

As indicated in FIG. 1, when the sledge estimation velocity SEV is higher than the first velocity threshold Vth1 (the quality of the servo signal is poor at this moment), then the switch SW1 is turned off, so that the sledge close loop control is disabled and the lens feedback controller 116 is also disabled due to lacking of the input of the signal e. When the switch SW1 is turned off, the second order observing unit 112 estimates the sledge estimation displacement signal SED and the sledge estimation velocity signal SEV according to the signal u2. Meanwhile, the sledge estimation displacement signal SED and the sledge estimation velocity signal SEV are estimated by open loop control.

The switch SW2 avoids discontinuity in the output of the lens feedback controller 116. During the decelerating process, when the speed is decelerated to the medium speed, since the switch SW1 is already turned on but the switch SW2 is turned off, the lens feedback controller 116 calculates and obtains the stable output value u_{fb}. When the speed is decelerated to the low speed, at the instant the switch SW2 is switched to turn on, the lens feedback controller 116 immediately outputs the stable output value u_{fb} to the calculating unit 117 for obtaining the signal u1.

In the present embodiment of the disclosure, the second order observing unit and a plurality of controllers are digitalized so that the present embodiment of the disclosure is for example implemented by a micro-processor. Let the sledge model be

$$\frac{{k}_{2}}{s ( s + p )}$$

and the lens model be

$$\frac{{k}_{1}}{{s}^{2} + b \cdot s + k} .$$

The equation (5) of the second order observing unit is digitalized as the following equation (10):

$$\hat{X} ( k + 1 ) = [ \begin{matrix}1 & K L J A 1 \\ 0 & 1 - K L J A 2\end{matrix} ] \hat{X ( k )} + [ \begin{matrix}K L J B 1 \\ K L J B 2\end{matrix} ] {u}_{2} ( k ) + [ \begin{matrix}K L J L 1 \\ K L J L 2\end{matrix} ] e ( k ) \qquad ( 10 )$$

KLJA1, KLJA2, KLJB1 and KLJB2 respectively denote the parameters obtained by transforming the parameters of the sledge mathematical model to the Z zone from the S zone; and KLJL1 and KLJL2 are the pole positions of the second order observing unit obtained according to the Ackermann theory.

Likewise, the equation (9) is digitalized as the equation (11) below:

u_{ff}(k)=KLJFFU·u₂(k)−KLJFFP·{dot over (\hat{x}ₛ(k) (11)

KLJFFU is a digital parameter of the lens feedforward controller, and is equal to

$$\frac{{k}_{2}}{{k}_{1}} ;$$

and KLJFFP a digital parameter of the lens feedforward controller, and is equal to

$$\frac{p}{{k}_{1}}$$

The mathematical model of the lens feedback controller is digitalized as the equation (12) below:

$${u}_{fb} ( k ) = \frac{K L J G 1 + K L J G 1 \cdot {z}^{- 1}}{1 - K L J G 3 \cdot {z}^{- 1}} e \qquad ( 12 )$$

KLJG1 and KLJG2 are parameters of the lens feedback controller, and normally KLJG1=−KLJG2 so that the lens feedback controller is a D-TYPE controller, and KLJG1 and KLJG2 determine the gain values of the controller; and KLJG3 is a parameter of the lens feedback controller, for implementing a low-pass filter. If KLJG3=0, this implies that the lens feedback controller does not have a low-pass filter. In the present embodiment of the disclosure, the lens feedback controller may optionally have a low-pass filter.

The jump profile generator is digitalized as the equation (13) below:

SVREF(k)=LJ_SPD_SLOPE·\hat{x}ₛ(k)+LJ_SPD_END (13)

LJ_SPD_SLOPE is the slope of the sledge estimation velocity signal SEV vs. the number of remaining tracks, and LJ_SPD_END is a final sledge estimation velocity signal SEV when arriving the target track, and normally ranges between 4˜6 kHz.

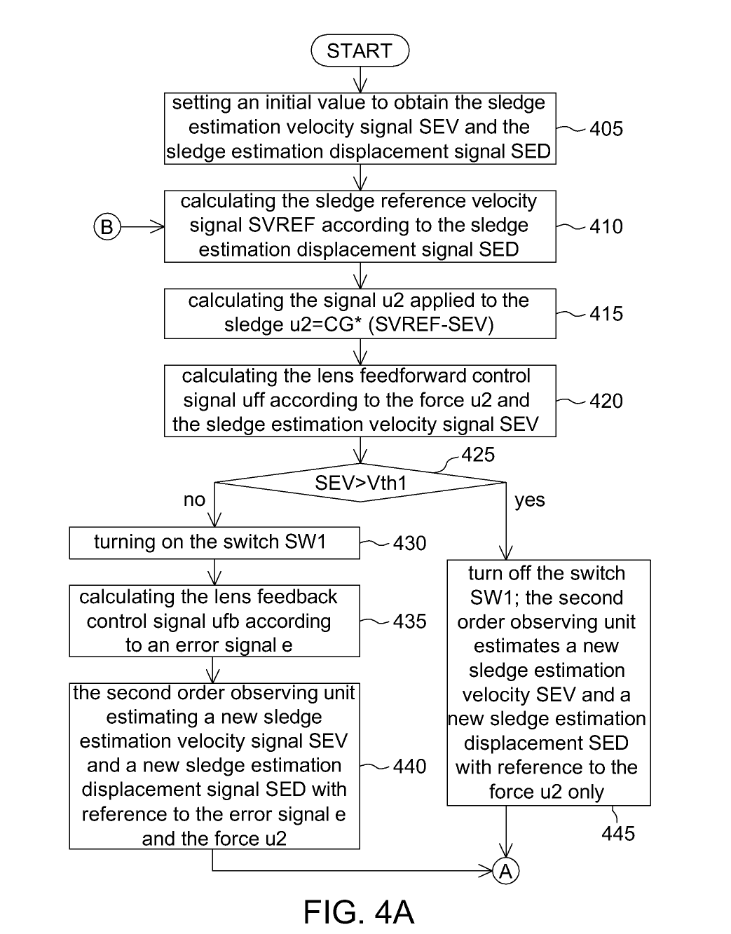

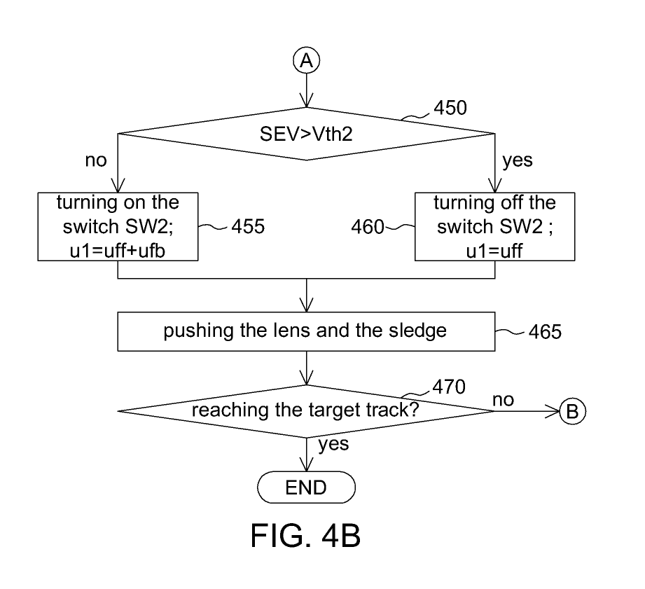

Referring to FIG. 4A and FIG. 4B, a flow chart according to the present embodiment of the disclosure is shown. In step 405, an initial value is set to obtain the sledge estimation velocity signal SEV and the sledge estimation displacement signal SED. The step 405 is implemented by such as the second order observing unit 112. In step 410, the sledge reference velocity signal SVREF is calculated according to the sledge estimation displacement signal SED. The step 410 is implemented by such as the jump profile generator 113.

In step 415, the signal u2 applied to the sledge is calculated, according to an equation u2=CG*(SVREF−SEV) disclosed above. The step 415 is implemented by such as the gain control unit 114.

In step 420, the lens feedforward control signal u_{ff} is calculated according to the force u2 and the sledge estimation velocity signal SEV. The step 420 is implemented by such as the lens feedforward controller 115.

In step 425, whether the sledge estimation velocity signal SEV is higher than the first velocity threshold Vth1 is judged to determine whether the switch SW1 is turned on or not. If yes, then the method proceeds to step 445, otherwise, the method proceeds to step 430.

In step 430, the switch SW1 is turned on. In step 435, the lens feedback control signal u_{fb} is calculated according to error signal e. The step 435 is implemented by such as the lens feedback controller 116. In step 440, the second order observing unit estimates a new sledge estimation velocity signal SEV and a new sledge estimation displacement signal SED (at the next timing) with reference to the error signal e and the force u2. The step 440 is implemented by such as the second order observing unit 112. That is, in step 440, when in low speed of in medium speed (SEV<Vth1), the second order observing unit generates the sledge estimation velocity signal SEV and the sledge estimation displacement signal SED by close loop control.

In step 445, the switch SW1 is turned off, so that the error signal e cannot be fed back to the second order observing unit 112, and the second order observing unit can only estimate the new sledge estimation velocity SEV and the new sledge estimation displacement SED with reference to the force u2. That is, in step 445, when in high speed (SEV>Vth1), the second order observing unit generates the sledge estimation velocity signal SEV and the sledge estimation displacement signal SED by open loop control.

In step 450, whether the sledge estimation velocity signal SEV is higher than the second velocity threshold Vth2 is judged so as to determine whether the switch SW2 is turned on or not. If yes, then the method proceeds to step 460, otherwise, then the method proceeds to step 455.

In step 455, the switch SW2 is turned on; and the force u1 applied to the lens is generated based on the lens feedforward control signal u_{ff} and the lens feedback control signal u_{fb} such as u1=u_{ff}+u_{fb}. That is, in step 455, when in low speed zone (SEV<Vth2), the force u1 applied to the lens is generated by close loop control. Further, during the sledge is decelerated to a low speed, turn on of the switch SW1 is earlier than turn on of the switch SW2. During the period from the turn on of the switch SW1 to the turn on of the switch SW2, the error signal e is already inputted to the lens feedback controller 116, so that the lens feedback controller 116 can calculate the lens feedback control signal u_{fb}. After the switch SW2 is switched to be turned on, the lens feedback controller 116 is already able to output a stable lens feedback control signal u_{fb}, hence reducing the discontinuities of the lens feedback control signal u_{fb}.

In step 460, the switch SW2 is turned off; and the force u1 applied to the lens is generated based on the lens feedforward control signal u_{ff} only, such as u1=u_{ff}. That is, in step 460, when in medium speed of in high speed (SEV>Vth2), the force u1 applied to the lens is generated by open loop control.

In step 465, the lens and the sledge are pushed by the obtained signals u1 and u2. In step 470, whether the target track is reached is judged. If the target track is not yet reached, then the method returns to step 410, and the process is repeated until the target track is reached.

It will be appreciated by those skilled in the art that changes could be made to the disclosed embodiments described above without departing from the broad inventive concept thereof. It is understood, therefore, that the disclosed embodiments are not limited to the particular examples disclosed, but is intended to cover modifications within the spirit and scope of the disclosed embodiments as defined by the claims that follow.

What is claimed is:

1. A long seeking control method for an optical information reproduction/recoding system having a lens and a sledge, comprising:
obtaining a sledge estimation velocity, a sledge estimation displacement, a sledge reference velocity and a first force applied to the sledge;
determining to generate the sledge estimation velocity and the sledge estimation displacement by a first open loop control or a first close loop control according to the sledge estimation velocity;
determining to generate a second force applied to the lens by a second open loop control or a second close loop control according to the sledge estimation velocity; and
pushing the sledge and the lens by the first force and the second force.

2. The long tracking control method according to claim 1, wherein, the step of obtaining the sledge estimation velocity, the sledge estimation displacement, the sledge reference velocity and the first force applied to the sledge comprises:
setting an initial value to obtain the sledge estimation velocity and the sledge estimation displacement;
obtaining the sledge reference velocity according to the sledge estimation displacement signal; and
obtaining the first force applied to the sledge according to a control gain and a difference between the sledge estimation displacement signal and the sledge reference velocity.

3. The long tracking control method according to claim 1, wherein, the step of determining to generate the sledge estimation velocity and the sledge estimation displacement by the first open loop control or the first close loop control according to the sledge estimation velocity comprises:
generating the sledge estimation velocity and the sledge estimation displacement by the first open loop control if the sledge estimation velocity is lower than a first velocity threshold; and
generating the sledge estimation velocity and the sledge estimation displacement by the first open loop control if the sledge estimation velocity is higher than the first velocity threshold.

4. The long tracking control method according to claim 3, wherein, the step of generating the sledge estimation velocity and the sledge estimation displacement by way of the first open loop control comprises:
calculating a track across amount to generate a laser beam displacement error signal according to the sledge estimation displacement and the track amount;
feeding back the laser beam displacement error signal if the sledge estimation velocity is lower than the first velocity threshold; and
generating the sledge estimation velocity and the sledge estimation displacement according to the laser beam displacement error signal and the first force.

5. The long tracking control method according to claim 4, wherein, the step of generating the sledge estimation velocity and the sledge estimation displacement by way of the first open loop control comprises:
breaking a feedback path of the laser beam displacement error signal if the sledge estimation velocity is higher than the first velocity threshold; and
generating the sledge estimation velocity and the sledge estimation displacement according to the first force only.

6. The long tracking control method according to claim 5, wherein, the step of determining to generate the second force applied to the lens by the second open loop control or the second close loop control according to the sledge estimation velocity comprises:
generating the second force applied to the lens by the second close control if the sledge estimation velocity is lower than a second velocity threshold; and
generating the second force applied to the lens by the second open loop control if the sledge estimation velocity is higher than the second velocity threshold.

7. The long tracking control method according to claim 6, wherein, the step of generating the second force applied to the lens by the second close control comprises:
feeding back the laser beam displacement error signal to generate the second force according to the first force, the sledge estimation velocity and the laser beam displacement error signal if the sledge estimation velocity is lower than the second velocity threshold.

8. The long tracking control method according to claim 7, wherein, the step of generating the second force applied to the lens by the second open loop control comprises:
breaking the feedback of the laser beam displacement error signal to generate the second force according to the first force and the sledge estimation velocity if the sledge estimation velocity is higher than the second velocity threshold.

9. The long tracking control method according to claim 1, wherein,
if in an accelerating state, a first time point at which the first close loop control is switched to the first open loop control is later than a second time point at which the second close loop control is switched to the second open loop control; and
if in a decelerating state, a third time point at which the first open loop control is switched to the first close loop control is earlier than a fourth time point at which the second open loop control is switched to the second close loop control.

10. A long seeking control system for an optical information reproduction/recoding system comprising a lens and a sledge, comprising:
a second order observing unit, generating a sledge estimation displacement signal and a sledge estimation velocity signal, and further generating the sledge estimation velocity and the sledge estimation displacement by a first open loop control or a first close loop control according to the generated the sledge estimation velocity;
a jump profile generator, generating a sledge reference velocity signal according to the sledge estimation displacement signal;
a gain control unit, generating a first force applied to the sledge according to the sledge estimation velocity signal and the sledge reference velocity signal; and
a lens controller, generating a second force applied to the lens according to the sledge estimation velocity signal and the first force signal, and generates the second force applied to the lens by a second open loop control or a second close loop control according to the sledge estimation velocity.

11. The long tracking control system according to claim 10, further comprising:
a track counting unit, calculating a track across amount to generate a laser beam displacement error signal according to the sledge estimation displacement and the track amount.

12. The long tracking control system according to claim 11, wherein,
if the sledge estimation velocity is lower than a first velocity threshold, the laser beam displacement error signal is fed back to the second order observing unit, so that the second order observing unit generates the sledge estimation velocity and the sledge estimation displacement by the first open loop control; and
if the sledge estimation velocity is higher than the first velocity threshold, the laser beam displacement error signal is not fed back to the second order observing unit, so that the second order observing unit generates the sledge estimation velocity and the sledge estimation displacement by the first open loop control.

13. The long tracking control system according to claim 12, wherein, the lens controller comprises:
a lens feedforward controller, generating a first portion of the second force according to the sledge estimation velocity signal and the first force; and
a lens feedback controller, generating a second portion of the second force according to the laser beam displacement error signal;
wherein,
if the sledge estimation velocity is lower than a second velocity threshold, the laser beam displacement error signal is fed back to the lens feedback controller, so that the lens controller generates the second force applied to the lens by the second close control, the second force equal to the sum of the first portion and the second portion; and
if the sledge estimation velocity is higher than the second velocity threshold, the laser beam displacement error signal is not fed back to the lens feedback controller, so that the lens controller generate the second force applied to the lens by the second open loop control, and the second force equal to the first portion.

14. The long tracking control system according to claim 13, further comprising:
a first switch, controlling a first switching between the first open loop control and the first close loop control according to the sledge estimation velocity; and
a second switch, controlling a second switching between the second open loop control and the second close loop control according to the sledge estimation velocity;
wherein, the first switching and the second switching are not synchronized.

15. The long tracking control system according to claim 14, wherein,
if in an accelerating state, a first time point at which the first close loop control is switched to the first open loop control is later than a second time point at which the second close loop control is switched to the second open loop control; and
if in a decelerating state, a third time point at which the first open loop control is switched to the first close loop control is earlier than a fourth time point at which the second open loop control is switched to the second close loop control.

16. The long tracking control system according to claim 10, wherein, the gain control unit generates the first force signal to the second order observing unit and the lens controller according to a control gain and a difference between the sledge estimation velocity signal and the sledge reference velocity signal.
